(19) United States
(12) Patent Application Publication
(10) Pub. No.: US 2026/0101007 A1
(43) Pub. Date: Apr. 9, 2026

(54) COMMUNICATION SYSTEM AND METHOD

(71) Applicant: Afiniti AI Limited, Dublin (IE)

(72) Inventors: Akbar A. MERCHANT, Bethesda, MD (US); Vikash KHATRI, Aldie, VA (US)

(73) Assignee: Afiniti AI Limited, Dublin (IE)

(21) Appl. No.: 19/416,493

(22) Filed: Dec. 11, 2025

Related U.S. Application Data
(63) Continuation of application No. PCT/US2024/033857, filed on Jun. 13, 2024.
(60) Provisional application No. 63/472,982, filed on Jun. 14, 2023.

(51) Int. Cl. H04M 3/523; H04M 3/51

(52) U.S. Cl. CPC H04M 3/5235; H04M 3/5191

(57) ABSTRACT

A communication system comprising a set of databases, a processing module, a pairing module, and a communication switch network. The processing module may determine a first plurality of joining strategies based on fields in the set of databases, obtain a plurality of sets of joined interaction-records based on the first plurality of joining strategies, determine respective measurements of the first plurality of joining strategies based on an overlap between one set of joined interaction-outcome records and another set of joined interaction-outcome records; and determine a reference set of joined interaction-outcome records based on the respective measurements of the plurality of joining strategies. The pairing module may determine a contact-agent pairing strategy based on the reference set, and the communication switch network may connect a contact with an agent based on the contact-agent pairing strategy.

### CROSS-REFERENCE TO RELATED APPLICATIONS

This application is a continuation of International patent application no. PCT/US2024/033857, filed on 2024-06-13, which claims the benefit of U.S. provisional patent application no. 63/472,982, filed on 2023-06-14. The above identified applications are incorporated by this reference.

### TECHNICAL FIELD

The invention relates generally to a communication system and method. More particularly, embodiments of the present disclosure relate to data processing methods for e.g. routing, pairing, assigning and/or recommending tasks in a communication system.

### BACKGROUND OF INVENTION

A typical communication system describes information exchange between at least two points. For example, a typical contact center system builds up information exchange links between arriving contacts and available agents. At times, the contact center system may have agents available and waiting for assignment to inbound or outbound contacts (e.g., telephone calls, Internet chat sessions, emails, etc.). At other times, the contact center system may have contacts arriving in one or more queues for an agent to become available for assignment. It would be understood that resource management problems are ubiquitous and challenging in communication systems and networks. Examples include relay/switch selection, congestion control, memory/storage management, bandwidth and processing power constraints, and so on.

In some examples, contacts are assigned to agents ordered based on time of arrival, and agents receive contacts ordered based on the time when those agents became available. This method may be referred to as a "first-in, first-out" ("FIFO"), or "round-robin" method. Once a FIFO method has been established, assignment of contacts to agents is automatic, with the contact center assigning the first contact in the ordering to the next available agent, or assigning the first agent in the ordering to the next arriving contact.

In other examples, other methods may be used, such as "performance-based routing" ("PBR") method. For example, when a contact arrives at a contact center with a plurality of available agents, the ordering of agents available for assignment to that contact would be headed by the highest-performing available agent (e.g., the available agent with the highest sales conversion rate, the highest customer satisfaction scores, the shortest average handle time, the highest performing agent for the particular contact profile, the highest customer retention rate, the lowest customer retention cost, the highest rate of first-call resolution, etc.). The PBR methods attempt to maximize the expected outcome of each contact-agent interaction but do so typically without regard for utilizing agents in a contact center uniformly. Consequently, higher-performing agents may receive noticeably more contacts and feel overworked, while lower-performing agents may receive fewer contacts and idle longer, potentially reducing their opportunities for training and improvement as well as potentially reducing their compensation. Also, with the PBR and/or FIFO methods, the agent resources may not be optimally used.

In other examples, contacts are paired with agents using a "behavioural pairing" ("BP") or "machine-learning based recommending" ("MLBR") method, under which contacts and agents may be deliberately or preferentially paired in a fashion that enables the assignment of subsequent contact-agent pairs such that when the benefits of all the assignments under a BP/MLBR method are totalled they may exceed those of FIFO and other methods such as PBR methods. The BP/MLBR methods are designed to encourage balanced utilization of agents within a skill queue while nevertheless simultaneously improving overall contact center or communication system performance beyond what FIFO or PBR methods will allow. This is a remarkable achievement in as much as BP acts on the same contacts and same agents as or more contracts and/or agents than FIFO or PBR methods, utilizes agents approximately evenly, and yet improves overall contact center or communication system performance.

The BP method is described in, e.g., U.S. Patent Nos. 9,300,802, 9,781,269, 9,787,841, 9,930,180, and 10,757,262, which are incorporated by reference herein. Additional information about these and other features regarding the pairing or matching modules (sometimes also referred to as "SATMAP", "routing system", "routing 10 engine", etc.) is described in, for example, U.S. Patent No. 8,879,715, which is incorporated by reference herein.

A BP or MLBR method may use outcomes of interactions between contacts and agents to generate and iteratively improve pairing models. However, in some examples, outcome records may be stored separately and in an unstructured/unrelated manner relative to interaction records of contacts and agents. Additionally or alternatively, information or data associated with one interaction or outcome record may have different fields and values which may be stored separately, such that each interaction may have a set of records associated with the interaction. Each record may have an unstructured/unrelated manner relative to each other record for the same interaction. Providing quality data (e.g. accurately matched records for a single interaction or outcome) for using in, e.g. machine learning models or other mathematic models for recommending or pairing purposes, has been recognised as a challenging problem in at least the data processing field, or, in particular, the computer science field.

In view of the foregoing, it would be appreciated that there may be a need for method and system that improves the accuracy and efficiency for joining multiple databases with, e.g., communication interaction data and/or communication outcome data to improve the efficiency and performance of resource management, communication routing, pairing, assigning and/or recommending in a communication system.

Any reference to or discussion of any document, act or item of knowledge in this specification is included solely for the purpose of providing a context for the present invention. It is not suggested or represented that any of these matters or any combination thereof formed at the priority date part of the common general knowledge, or was known to be relevant to an attempt to solve any problem with which this specification is concerned.

### SUMMARY OF INVENTION

Depending on different applications that the communication system is used for, the present disclosure provides for an improved overall performance for the communication system that may include but not be limited to efficient operations of the communication systems including increasing the number of incoming tasks/queries that the related contact center can complete, reducing excessive delays and latency for the related contact center to handle the incoming tasks/queries, efficient utilization of agent resources, reduced time for problems to be solved, improved revenue, improved user (contacts and/or agents) experience/satisfaction, etc.

Accordingly, the present disclosure provides a newly developed communication systems and methods with improved database joining methods which may improve accuracy and efficiency in combining or matching records in different databases so as to provide improved resource management, communication routing, pairing, assignment and/or recommending methods and systems.

An improved system and method for accurately and efficiently joining records from a plurality of databases so as to efficiently operate a communication system is provided.

According to a first aspect of the present disclosure there is provided a communication system comprising a first database, a second database, at least one data processing module, at least one pairing module, and at least one communication switch network. The first database is configured to provide a first plurality of communication interaction records, wherein each communication interaction record in the first plurality of communication interaction records comprises first values for a first set of fields. The second database is configured to provide a first plurality of communication outcome records, wherein each communication outcome record in the first plurality of communication outcome records comprises second values for a second set of fields. The at least one data processing module is configured to: determine a first plurality of joining strategies based on at least some of the first set of fields and the second set of fields; obtain a plurality of sets of joined interaction-outcome records, wherein each set of joined interaction-outcome records is obtained based on a corresponding joining strategy, and each record of each set of joined interaction-outcome records comprises one record of the first plurality of communication interaction records and one record of the first plurality of communication outcome records; determine respective measurements of the first plurality of joining strategies based on an overlap between one set of joined interaction-outcome records and another set of joined interaction-outcome records; and determine a reference set of joined interaction-outcome records based on the respective measurements of the plurality of joining strategies. The at least one pairing module is configured to determine at least one contact-agent pairing strategy for at least one contact center system based on the reference set of joined interaction-outcome records. The at least one communication switch network is configured to connect a contact with an agent based on the at least one contact-agent pairing strategy.

In some embodiments, the first set of fields comprises fields associated with a contact-agent interaction at the at least one contact center system.

In some embodiments, the second set of fields comprises fields associated with an outcome of a contact-agent interaction at the at least one contact center system.

In some embodiments, the reference set of joined interaction-outcome records comprises at least one of: records in a first set of joined interaction-outcome records obtained based on a first joining strategy of the plurality of joining strategies, records in a second set of joined interaction-outcome records obtained based on a second joining strategy of the plurality of joining strategies, and/or a combination of records in the first set of joined interaction-outcome records and records in the second set of joined interaction-outcome records.

In some embodiments, the at least one data processing module is further configured to determine benchmarking between a first contact-agent pairing strategy and a second contact-agent pairing strategy based on the reference set of joined interaction-outcome records.

In some embodiments, the at least one communication switch network comprises at least one demilitarized zone equipment.

In some embodiments, the at least one communication switch network comprises at least one web demilitarized zone equipment and at least one telephony demilitarized zone equipment.

In some embodiments, the at least one data processing module is further configured to: determine a ranking for executing the first plurality of joining strategies based on the respective measurements of the plurality of joining strategies; and execute the first plurality of joining strategies to the first and second databases in a sequence according to the ranking.

In some embodiments, the at least one data processing module is further configured to: execute one joining strategy of the first plurality of joining strategies with a highest ranking to the first and second databases to obtain a set of joined interaction-outcome records; and execute another joining strategy of the first plurality of joining strategies with a lower ranking to unjoined records of the first and second databases.

In some embodiments, the respective measurements of the first plurality of joining strategies indicate respective joining confidence levels of the plurality of joining strategies.

In some embodiments, the at least one data processing module is further configured to determine at least one weight for at least one record in the reference set of joined interaction-outcome records.

In some embodiments, the at least one weight is determined based on the respective measurements of one or more of the first plurality of joining strategies.

In some embodiments, the at least one pairing module is configured to provide the at least one contact-agent pairing strategy for the at least one contact center system based on the reference set of joined interaction-outcome records and the at least one weight of the at least one record of the reference set of joined interaction-outcome records.

In some embodiments, the communication system further comprises a third database configured to provide a second plurality of communication interaction records, wherein each communication interaction record in the second plurality of communication interaction records comprises third values for a third set of fields; and a fourth database configured to provide a third plurality of communication interaction records, wherein each communication interaction record in the third plurality of communication interaction records comprises fourth values for a fourth set of fields, wherein the third set of fields is different from the fourth set of fields. The at least one data processing module is configured to obtain the first plurality of communication interaction records by joining the second plurality of communication interaction records and the third plurality of communication interaction records based on at least one of the first plurality of joining strategies.

In some embodiments, the communication system further comprises a third database configured to provide a second plurality of communication interaction records, wherein each communication interaction record in the second plurality of communication interaction records comprises third values for a third set of fields; and a fourth database configured to provide a third plurality of communication interaction records, wherein each communication interaction record in the third plurality of communication interaction records comprises fourth values for a fourth set of fields. The at least one data processing module is further configured to determine a second plurality of joining strategies; and obtain the first plurality of communication interaction records by joining the second plurality of communication interaction records and the third plurality of communication interaction records based on at least one of the second plurality of joining strategies.

The present disclosure further provides a second aspect of the invention, including a method comprising: obtaining a first plurality of communication interaction records from a first database, wherein each communication interaction record in the first plurality of communication interaction records comprises first values for a first set of fields; obtaining a first plurality of communication outcome records from a second database, wherein each communication outcome record in the first plurality of communication outcome records comprises second values for a second set of fields; determining a first plurality of joining strategies based on at least some of the first set of fields and the second set of fields; obtaining a plurality of sets of joined interaction-outcome records, wherein each set of joined interaction-outcome records is obtained based on a corresponding joining strategy, and each record of each set of joined interaction-outcome records comprises one record of the first plurality of communication interaction records and one record of the first plurality of communication outcome records; determining respective measurements of the first plurality of joining strategies based on an overlap between one set of joined interaction-outcome records and another set of joined interaction-outcome records; and determining a reference set of joined interaction-outcome records based on the respective measurements of the plurality of joining strategies.

Various embodiments of the second aspect of the present invention may be as described regarding the first aspect of the present invention.

Further aspects of the present invention and further embodiments of the aspects described in the preceding paragraphs will become apparent from the following description, given by way of example and with reference to the accompanying drawings.

### BRIEF DESCRIPTION OF DRAWINGS

Embodiments of the invention will now be described with reference to the accompanying drawings. It is to be understood that the embodiments are given by way of illustration only and the invention is not limited by this illustration. In the drawings:

FIG. 1A illustrates a block diagram of an exemplary communication system;

FIG. 1B illustrates a block diagram of another exemplary communication system;

FIG. 1C illustrates a block diagram of an exemplary communication system with an exemplary configuration of a Contact Center as a Service (CCaaS);

FIG. 1D illustrates an exemplary CCaaS configuration supporting multi-tenancy;

FIG. 2 illustrates a block diagram of an exemplary computing system configured to implement one or more embodiments/features of the present disclosure;

FIG. 3 illustrates a first exemplary database with a plurality of communication interaction records and a second exemplary database with a plurality of communication outcome records;

FIG. 4 illustrates an agreement matrix demonstrating an agreement between two of multiple joining strategies.

FIG. 5 illustrates a plurality of joined interaction-outcome records based on the exemplary databases of FIG. 3;

FIG. 6 illustrates third and fourth exemplary databases each with a plurality of communication interaction records; and

FIG. 7 illustrates a plurality of exemplary joined interaction records based on the exemplary databases of FIG. 6.

### DETAILED DESCRIPTION

### 1. Communication system

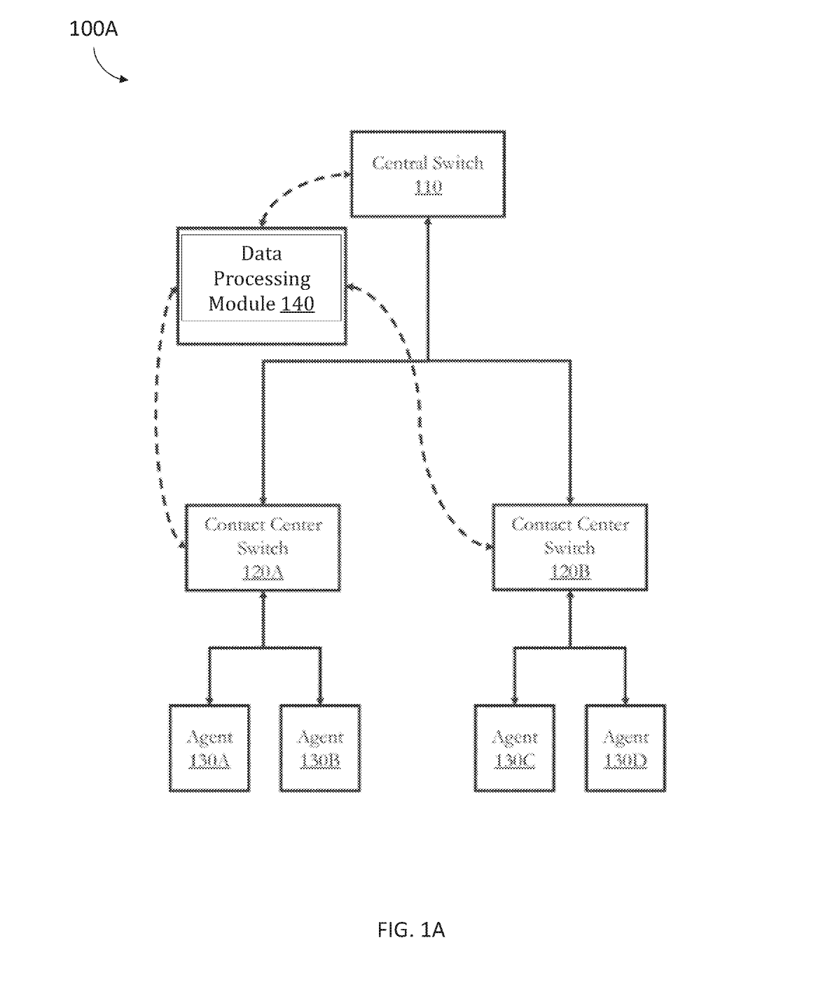

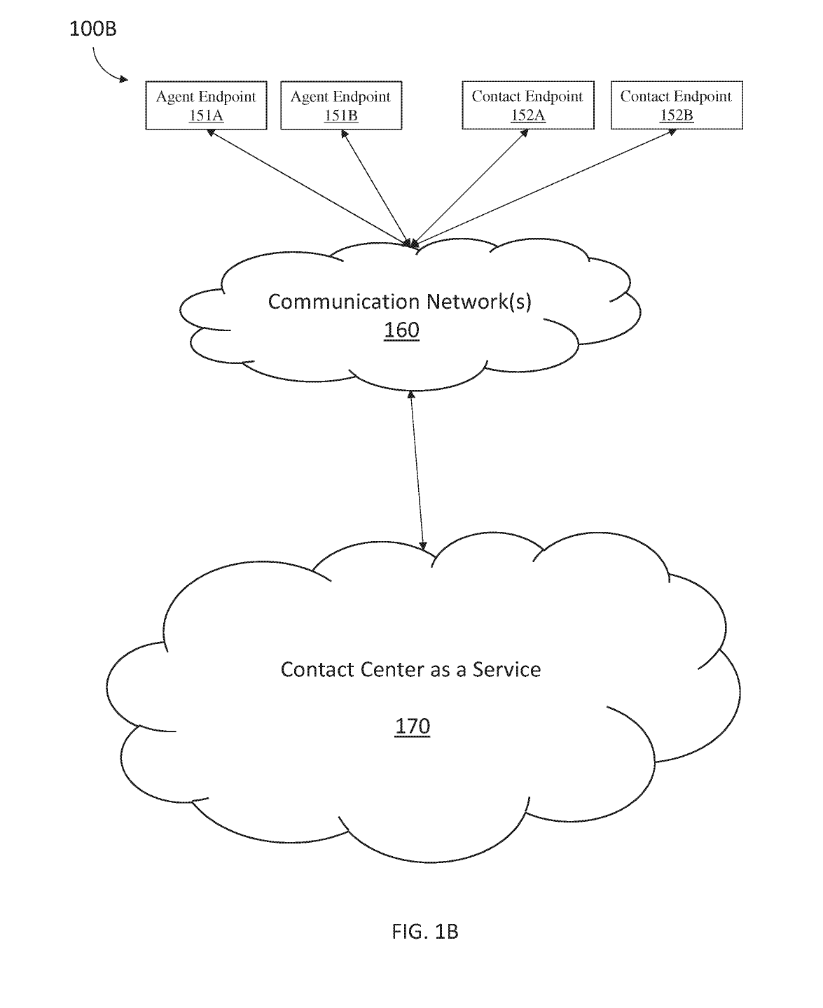

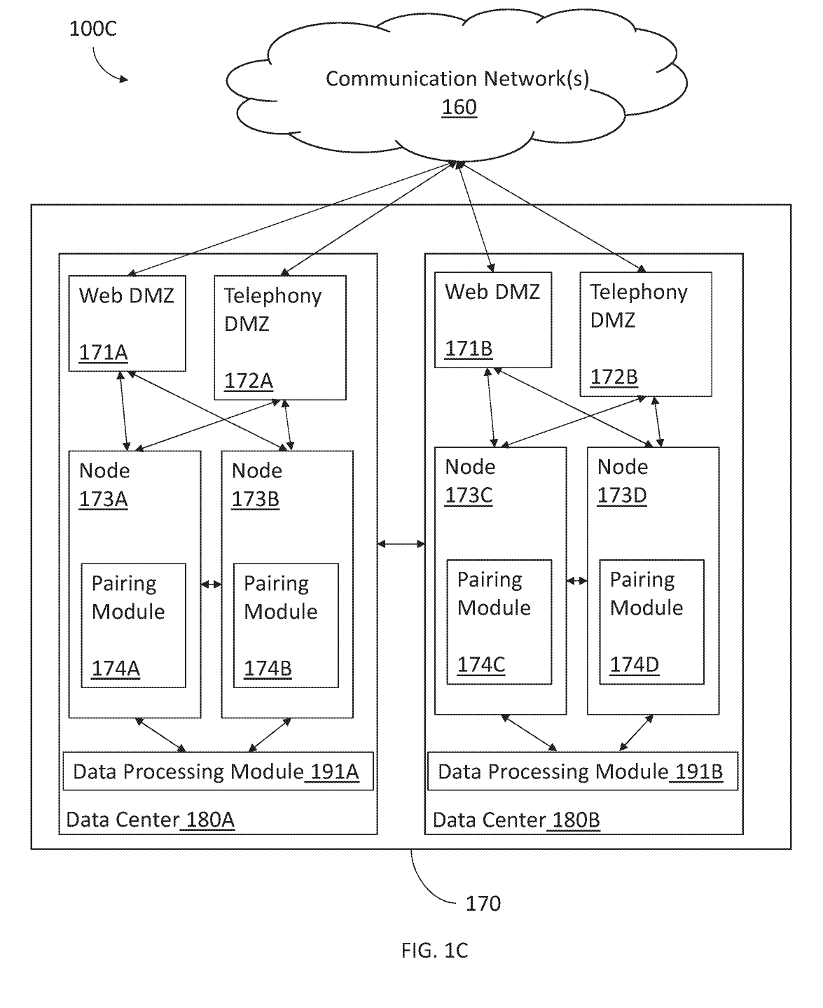

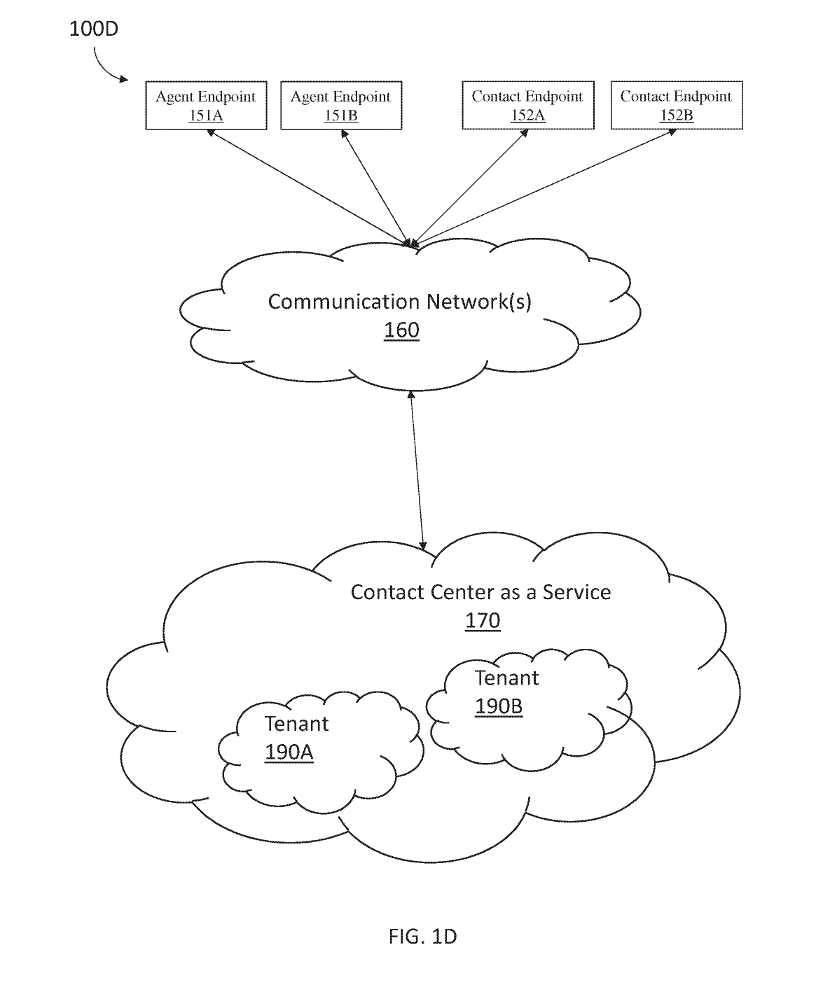

FIG. 1A illustrates a block diagram of an exemplary communication system 100A according to embodiments of the present disclosure. The contact system 100 may include a central switch 110. The central switch 110 may receive incoming contacts (e.g. callers) and/or support outbound connections to contacts via a network (e.g. a telecommunications network, not shown). The central switch 110 may include contact routing hardware and software for routing contacts among one or more contact center systems, or to one or more Private Branch Exchange (PBX)/Automated Call Distribution (ACD) routing systems, or other queuing/switching components, including e.g. other Internet-based, cloud-based, or otherwise networked contact-agent hardware or software-based contact center solutions.

In some embodiments, the central switch 110 may be omitted such as if there in only one contact center system, or if there is only one PBX/ACD routing component, in the communication system 100A. In other embodiments, where more than one contact center systems are included in the communication system 100, each contact center system may include at least one contact center switch (e.g. contact center switches 120A and 120B). The at least one contact center switch (e.g. 120A and 120B) may be communicatively coupled to the central switch 110. Various topologies of routing and network components may be configured to implement the contact center system.

Each of the at least one contact center switch (e.g 120A and 120B) may be communicatively coupled to at least one agents or a "pool" of agents. Each of the at least one contact center switch (e.g. 120A and 120B) may support a certain number of agents (or "seats") to be logged in at one time. At any given time, a logged-in agent may be available and waiting to be assigned/connected to a contact, or the logged-in agent may be unavailable for one or more reasons, such as being connected to another contact, performing certain post-interaction functions such as logging information about the contact-agent interaction, logging information about outcome(s) and/or feedback of the contact-agent interaction, or taking a break.

In the exemplary configuration of FIG. 1A, the central switch 110 routes contacts to one of the at least one contact centers (two contact centers in this illustrated example), respectively. As illustrated, each of two contact center switches 120A and 120B is communicatively coupled with two agents. That is, agents 130A and 130B are connected with contact center switch 120A while agents 130C and 130D are connected with contact center switch 120B.

The communication system 100A may also be communicatively coupled to a service (e.g., integrated with the communication system) or include a service for operating the at least one contact center switch (e.g. 120A and 120B). The service may be provided by a third party vendor. In the example of FIG. 1A, the service may include a data processing module 140 communicatively coupled to one or more switches (e.g., central switch 110, contact center switch120A and/or contact center switch 120B) in the communication system 100A. In other examples, the one or more switches of the communication system 100A may be communicatively coupled to multiple data processing modules.

In some embodiments, at least one data processing module (e.g. 140) may be embedded within or otherwise integrated with a component of the communication system 100A. For example, the at least one data processing module (e.g. 140) may be embedded in or otherwise integrated with a communication switch. The at least one data processing module may receive information from the at least one switch in the communication system 100A and/or from a network (e.g. an Internet network and/or a telecommunication network, not shown) about one or more agents logged into the at least one switch and/or one or more incoming contacts. For example, the data processing module may receive information from the contact center switch 120a about agents logged into the switch (e.g. agents 130A and 130B) and receive information from the central switch 110 about incoming contacts.

A communication system may include one or more pairing modules (not shown) for resource/communication routing, pairing, and/or task assignment so as to operate the at least one contact center switch in the communication system accordingly, and the one or more pairing modules may be provided by one or more different vendors. In some embodiments, one or more of the pairing module(s) may be included in the data processing module 140 and/or one or more communication switch such as central switch 110 and/or contact center switches (e.g. 120A and 120B). In other embodiments, one or more of the pairing module(s) may be independent modules but communicatively coupled to the data processing module 140 and/or one or more communication switch such as central switch 110 and contact center switches (e.g. 120A and 120B). Each of the one or more pairing modules may be configured to implement a different pairing strategy/algorithm. Additionally or alternatively, one pairing module may be configured to implement a plurality of different pairing strategies/algorithms. In some embodiments, the one or more data processing modules or a pairing module may determine which pairing module may handle the pairing task(s) for a particular contact. For example, a first pairing module may alternate enabling pairing via the first pairing module and enabling pairing via a second pairing module.

In some embodiments, regardless of whether pairing strategies are implemented or pairing recommendations are made by separate pairing modules, or if some pairing strategies are implemented or pairing recommendations are made within a single pairing module, a pairing module may be configured to monitor/observe and store information about pairings made under at least one pairing strategies. For example, the first pairing module configured to implement a first pairing strategy may observe and record data about the pairings made based on a second pairing strategy by the second pairing module. In another example, the first pairing module configured to implement the first and second pairing strategies may observe and record data about the pairings made based on the first and/or second pairing strategies.

FIG. 1B illustrates a block diagram of another exemplary communication system 100B according to embodiments of the present disclosure. As shown in FIG. 1B, the communication system 100B includes one or more agent endpoints (e.g. 151A and 151B) and one or more contact endpoints (e.g. 152A and 152B). Each of the one or more agent endpoints and the one or more contact endpoints may include at least one terminal and/or computing system (e.g. laptop, desktop, cellphone and/or other electronic devices). The one or more agent endpoints 151A, 151B and/or the one or more contact points 152A, 152B may connect to a Contact Center as a Service (CCaaS) 170 through one or more communication networks (e.g. a local area network, a wide area network (e.g. Internet), a telephone network (e.g. a public switched telephone network (PSTN)), according to capabilities of respective endpoint terminals and/or computing systems.

FIG. 1C illustrates a block diagram of an exemplary communication system with an exemplary configuration of the CCaaS 170 of FIG. 1B. The CCaaS 170 may include at least one data center. In one example, the CCaaS 170 includes multiple data centers (e.g. 180A and 180B), which may be separated physically (e.g., in different countries and/or continents). The multiple data centers (e.g. 180A and 180B) may communicate with each other. For example, one data center (e.g. 180B) is a backup for another data center (e.g. 180A); so that, in some embodiments, only one data center in the backup pair (i.e. 180A) receives the one or more agent endpoints (e.g., 151A and 151B) and the one or more contact endpoints (152A and 152B) at a time.

Each of the at least one data centers (e.g., 180A, 180B) includes at least one communication switch network configured to connect a contact endpoint with an agent endpoint based on at least one contact-agent pairing strategy or at least one recommended pairing. The at least one communication switch network may include at least one demilitarized zone (DMZ) equipment. In some embodiments, the at least one communication switch network may include a web DMZ equipment (e.g., 171A, 171B for data center 180A and 180B, respectively), which is configured to receive the one or more agent endpoints (e.g., 151A and 151B) and the one or more contact endpoints (e.g., 152A and 152B) that are communicatively connecting to the CCaaS 170 via the local area network and/or the wide area network (e.g., Internet). Alternatively or additionally, the at least one communication switch network may include a telephony DMZ equipment (e.g., 172A, 172B for data center 180A and 180B, respectively), which is configured to receive the one or more agent endpoints (e.g., 151A and 151B) and the one or more contact endpoints (e.g., 152A and 152B) that are communicatively connecting to the CCaaS 170 via the telephone network (e.g., the public switched telephone network (PSTN)). The web DMZ equipment(s) (e.g., 171A, 171B) and the telephony DMZ equipment(s) (e.g., 172A, 172B) may operate outside a firewall to connect with the one or more agent endpoints (e.g., 151A and 151B) and the one or more contact endpoints (e.g., 152A and 152B) while the rest of the components of the at least one data centers (e.g., 180A, 180B) may operate within the firewall.

Further, each data center (e.g., 180A, 180B) may include one or more nodes (e.g., 173A and 173B in data center 180A, 173C and 173D in data center 180B). The one or more nodes 173A-173D may communicate with the web DMZ equipment(s) 171A and 171B, respectively, and with telephony DMZ equipment(s) 172A and 172B, respectively. In some embodiments, only one node in each data center 180A, 180B may be communicating with the corresponding web DMZ equipment and with the corresponding telephony DMZ equipment at a time.

Each node 173A, 173B, 173C, 173D may include one or more pairing modules (e.g., 174A, 174B, 174C, 174D, respectively as illustrated in FIG. 1C. As similarly discussed in regards to the pairing module(s) of the communication system 100A, the one or more pairing modules (e.g., 174A, 174B, 174C, 174D) are configured to provide at least one contact-agent pairing strategy or to recommend at least one contact-agent pairing for at least one contact center system so as to operate at least one communication switch network in the communication system accordingly, and each of the one or more pairing modules (e.g., 174A, 174B, 174C, 174D) at a node may comprise multiple pairing modules at the same node (not shown).

Each of the one or more pairing modules may be configured to implement a different pairing strategy/algorithm. Additionally or alternatively, one pairing module may be configured to implement a plurality of different pairing strategies/algorithms. In some embodiments, a pairing module may determine which pairing module may handle the pairing tasks for a particular contact. For example, a first pairing module may alternate enabling pairing via the first pairing module and enabling pairing via a second pairing module.

In some embodiments, regardless of whether pairing strategies are implemented or pairings are recommended by separate pairing modules, or if some pairing strategies are implemented by multiple pairing modules or pairings are recommended by a single pairing module, a pairing module may be configured to monitor/observe and store information about pairings made under at least one pairing strategy. For example, the first pairing module configured to implement a first pairing strategy may observe and record data about the pairings made based on a second pairing strategy by the second pairing module. In another example, the first pairing module configured to implement the first and second pairing strategies may observe and record data about the pairings made based on the first and/or second pairing strategies.

The at least one pairing strategy may include but not limited to strategies based on FIFO, PBR and/or BP methods. The at least one pairing module may include at least one machine learning model, or algorithm for training at least one machine learning model, that is configured to input contact center data, such as contact information, agent information, pairing information, joining data of outcome records and interaction records, or event data defining sequences or timing therefor, and/or one or more pairing strategies or algorithms of the communication system (e.g., communication system 100A, 100B) in order to provide a recommended pairing strategy and/or a recommended contact-agent pair for the incoming contact(s) and/or to predict, classify, or determine performance metrics of the contact center system and/or the communication system. Performance metrics may include any one or more of telecommunication resource/connection utilization of the communication system, a resource utilization of the contact center system, a contact resolution metric associated with one or more contacts, or a transaction metric associated with one or more contacts, task completion time, loyalty metrics, or other performance metrics. The at least one pairing module may be trained to determine improvements to any one of these performance metrics based on different sequences of contacts, agents, and/or pairing strategies currently recommended and/or utilized by the communication system.

In various aspects, the at least one machine learning model may be trained using a supervised learning, unsupervised learning and/or reinforcement learning program/algorithm. The machine learning program/algorithm may employ a neural network, which may be a deep learning neural network. In some embodiments, the artificial intelligence and/or machine learning based algorithm(s), as used to train the at least one machine learning model, may be included as at least one library.

The at least one pairing module may involve identifying and recognizing patterns in existing or historical data, such as contact center data or related event data (e.g., arrival time(s) of a contact(s) or availability of agent(s)), in order to facilitate to make predictions, identification or recommendation for subsequent or future input data. For example, the at least one machine learning model of the at least one pairing module may be created and trained based on training data set or reference data set as input data including one or more communication interaction records and one or more associated communication outcome data, e.g., data or information regarding contacts, agents, arrival times, log in and/or log out time, handle times, outcome information (e.g. sales, transaction and/or task completion information), communication connection status and/or utilization (e.g. switch information, bandwidth information), memory and/or processor resource utilization of the communication system, and/or other relevant information. In some embodiments, the input training/reference data set may be termed "features" and "labels". The trained at least one machine learning model of the at least one pairing module may then make recommendations and/or predictions for incoming inputs including, for example, testing level data and/or production level data, for e.g., determining pairing strategy, recommending contact-agent pair and/or determining performance metrics of the contact center system and/or the overall communication system.

In the embodiments using supervised learning techniques for the at least one machine learning model, a machine learning program (e.g., operating on a server, computing system, or otherwise processors) may be provided with example inputs (i.e., training or reference data set, which may be termed as “features”) and their associated, or observed, outputs (which may be termed as “labels” or "ground truth" or "external supervision signal") in order for the machine learning program or algorithm to determine or discover rules, relationships, patterns, or otherwise machine learning “models” that map such inputs (e.g., “features”) to the outputs (e.g., "labels"), for example, by determining and/or assigning weights or other metrics to the model across its various feature categories. Such rules, relationships, or otherwise models may then be applied to subsequent inputs in order for the model (e.g., executing on a server, computing system, or otherwise processors) to predict or classify or recommend, based on the discovered rules, relationships, or model, an expected output, pairing, score, or value.

In the embodiments using unsupervised learning techniques for the at least one machine learning model, the example inputs are unlabeled or are not provided with ground truths or external supervision signal(s). In some examples, a supervision signal may be derived from the example inputs. The machine learning program may be required to find its own structure in unlabeled example inputs, where, for example, multiple training iterations are executed by the server, computing system, or otherwise processors to train multiple generations of models until a satisfactory model, e.g., a model that provides sufficient prediction accuracy when given test level or production level data or inputs, is generated.

In the embodiments using reinforcement learning techniques for the at least one machine learning model, the machine learning program is configured to implement at least one method of rewarding desired actions (e.g., desired pairing/recommendation/pairing strategy) and punishing undesired actions (e.g. undesired paring/recommendation/pairing strategy). Different reinforcement rewards may be employed to support a variety of objectives/goals. The variety of objectives/goals may be based on at least one of the performance metrics including, e.g., one or more of telecommunication resource/connection utilization of the communication system, a resource utilization of the contact center, a contact resolution metric associated with one or more contacts, or a transaction metric associated with one or more contacts, task completion time, loyalty metrics, and/or other performance metrics.

The at least one machine learning model of the at least one pairing module using supervised learning, unsupervised machine and/or reinforcement learning techniques may further include retraining, relearning, or otherwise updating the at least one machine learning model with new or different training/reference data set, which may include information received, ingested, generated, or otherwise used over time. The at least one retrained machine learning model may be used to configure the at least one pairing module (e.g., 174A, 174B, 174C, 174D) and the at least one communication switch network (e.g., 171A, 172A, 171B, 172B) to operate according to a new or different pairing/paring strategy that has been determined based on the new or different training/reference data set. In such instances, the new or different paring/pairing strategy may be uploaded, transmitted or otherwise provided to the at least one pairing module (e.g., via a computer network or via a computer bus), where the at least one pairing module may cause the communication system (e.g., via configuration of one or more switches including the at least one communication switch network) to execute or implement the new or different pairing/paring strategy so as to connect an incoming contact with an agent.

Each data center (e.g., 180A, 180B) may include at least one data processing module (e.g., 191A and 191B, respectively) configured to provide the example inputs (i.e., training or reference data set) to the at least one pairing module (e.g., 174A and 174B, 174C and 174D, respectively). The at least one pairing module may be included within the at least one data processing module. Additionally or alternatively, the at least one pairing module may be in communication with the at least one data processing module. Methods of determining the training or reference data set are described in the "Data processing methods" section below.

Turning now to FIG. 1D, in some embodiments, the disclosed CCaaS configuration 170 may support multi-tenancy such that multiple contact center systems (or contact center operations or businesses) may be operate on a shared environment. That is, each tenant may have a separate, non-overlapping pool of agents. The exemplary CCaaS configuration 170 in FIG. 1D is illustrated as supporting two tenants 190A and 190B. In some examples, the tenant 190A may be supported by the node 173A as illustrated in FIG. 1C while the tenant 190B may be supported by the node 173B as illustrated in FIG. 1C. In other examples, the data center 180A of FIG. 1C supports tenant 190A while the data center 180B of FIG. 1C supports tenant 190B. In some examples, the multiple tenants may be supported through a shared machine or shared virtual machine such that node 173A may support the multiple tenants (e.g., both tenants 190A and 190B), and similarly for nodes 173B, 173C and 173D.

In other embodiments, the communication system including the CCaaS 170 may be configured for a single tenant within a dedicated environment such as a private machine or private virtual machine.

### 2. Computing system

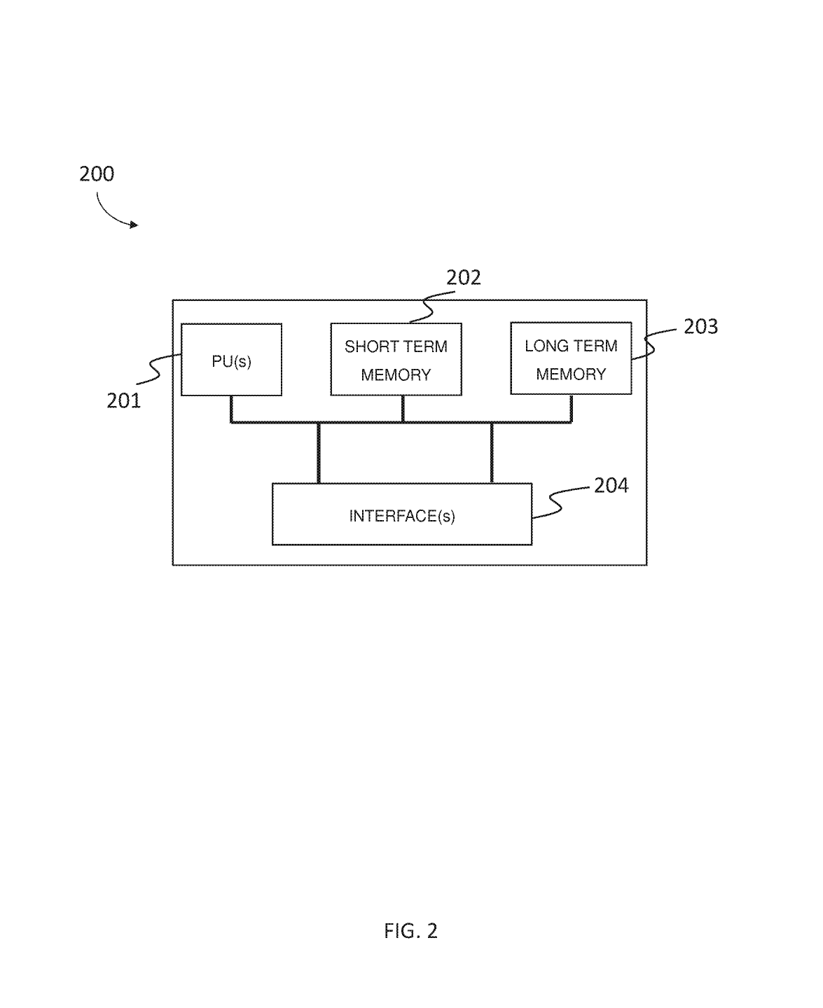

FIG. 2 illustrates a block diagram of an exemplary computing system 200 configured to implement one or more embodiments/features of the present disclosure. The at least one agent endpoint (e.g. 151A, 151B as illustrated in FIGS. 1B and 1D) and/or the at least one contact endpoint (e.g. 152A, 152B as illustrated in FIGS. 1B and 1D) may be associated with at least one computing system 200.

The computing system 200 (e.g. desktop, laptop, cellphone, or another type of electronic device) includes one or more processing units (PUs) 201 (e.g. one or more central processing units (CPUs), one or more graphics processing units, and/or other computational units). It will be appreciated that processing may be performed by the one or more processing units 201 and/or one or more remote processing systems (not shown) accessible and useable by the computing system 200. The computing system 200 may also include one or more machine readable storage/memory devices configured to store instructions and/or data for controlling operation of the computing system 200. The one or more machine readable storage/memory devices may include short term memory 202, e.g. random access memory (RAM) and/or longer term memory 203, e.g. one or more hard disk or solid state drives.

The computing system 200 may also include one or more interfaces 204 configured to interface the computing system 200 with one or more devices and/or networks. It will be appreciated that the one or more devices (not shown) connected to the computing system 200 via the one or more interfaces may be integral with or separate from the computing system 200. Connection(s) between the computing system 200 and the one or more devices and/or networks may be wired and/or wireless according to any appropriate standard or proprietary hardware and communications protocols.

In some embodiments, devices to which the computing system 200 connects include one or more input devices by which information and/or data is input into the computing system 10 for processing by e.g. the one or more processing units 201. For example, the one or more input devices include keyboards, mice, sensors (e.g. accelerometers, GPS devices, LiDAR sensors, etc.), microphones, trackpads, touch screen displays and the like. Devices to which the computing system 200 connects may additionally or alternatively include one or more output devices to which information and/or data is output by the computing system 200. For example, the one or more output devices include displays (e.g. LCD displays, LED displays, organic LED displays, plasma displays, touch screen displays), speakers, tactile output devices, indicators (e.g. light indicators), and the like. It will be appreciated that one or more of the devices that the computing system 200 connects to may act as both input and output devices.

It will be appreciated that FIG. 2 does not illustrate all functional or physical components of a computing system. For example, no power supply is depicted in FIG. 2. A person skilled in the art should understand that the computing system 200 may include an integrated power supply and/or be connected to an external power supply. It will also be appreciated that additional, fewer or alternative functional or physical components (e.g. additional network access modules, such as Wi-Fi modules) than those illustrated in FIG. 2 may be included in a computing system configured to implement the disclosed embodiments/features in the present disclosure. Furthermore, one or more of the components of the computing system 200 may be distributed across other computing systems. For example, the long term memory 203 may be physically located across a network.

### 3. Data processing methods

This section describes methods of determining the training or reference data set, which may be implemented by the at least one data processing module (e.g. 191A, 191B). The determined training or reference data set may be provided to the at least one pairing module for the at least one pairing module to determine at least one contact-agent pairing strategy and/or to recommend a contact-agent pair for incoming contacts.

In some embodiments, the communication system (e.g. 100A, 100B, 100C, 100D) may include one or more databases. For example, at least one database may be co-located with certain communication system equipment on premises. Various databases may be communicatively coupled to various communication system components. For example, the at least one communication switch (e.g. 120A, 120B, 171A, 172A, 171B, 172B) and/or the at least one pairing module (e.g. 174A, 174B, 174C, 174D) are/is communicatively coupled with at least one database. In other embodiments, at least one database may be communicatively coupled to the communication system from a remote (e.g. cloud-based) data center via a network connection. In other embodiments, a database may be co-located with certain communication system equipment on premises.

The training or reference data set may include a plurality of interaction-outcome records. However, in some embodiments, there are various databases associated with one contact center system. For example, the various databases may include at least one database (e.g., historical assignment database(s) and/or contact center database(s)), each of which includes a plurality of communication interaction records (e.g., records comprising fields associated with a contact-agent interaction at at least one contact center system), wherein each communication interaction record in the plurality of communication interaction records comprises first values for a first set of fields. The various databases may also include at least one database (e.g., outcome record database(s) and/or customer relationship management "CRM" database(s)), each of which includes a plurality of communication outcome records (e.g., records comprising fields associated with an outcome of a contact-agent interaction at least one contact center system), wherein each communication outcome record in the plurality of communication outcome records comprises second values for a second set of fields. In some embodiments, at least one field of the first set of fields for a first database is different from at least one field of the second set of fields for a second database. In some embodiments, one or more databases may be supplied by a third-party.

When a contact is paired/assigned with and connected to an agent, some information about the assignment may be stored in one or more databases. For example, a record of the assignment may be stored in at least one historical assignment database and/or at least one contact center database. The record may include an identifier for the contact (e.g., phone number, customer identifier (e.g. PIN, voice signature, etc.), email address, etc.), an identifier for the paired agent (e.g., agent ID, agent name, voice signature, etc.), a timestamp for the date and time when a pairing assignment for the contact-agent interaction was made, and other information relevant to the assignment. For example, the record may further include information about the contact's journey through the contact center system, such as interactive voice response ("IVR") or touch-tone menu selections that the contact may have made prior to being assigned to the agent in the example of a telephone call. In some embodiments, the at least one pairing strategies that was/were used to make the assignment may be stored in one or more databases. In some embodiments, whether the assignment was an optimized choice or a constrained choice (with or without relevant constraints) may be stored in one or more databases.

During the interaction and/or after the end of the interaction, one or more outcomes of the interaction may be stored in one or more databases. For example, the assigned agent may type notes into the associated computing system which may be stored in at least one contact center database for reference during future interactions. In a sales application, the assignment agent may record a sales transaction. Information about the sales transaction may be stored in, for example, at least one outcome record database and/or at least one "CRM" database. In a customer support application, the assigned agent may record and/or update the contact's records in one of the databases to reflect the resolution of the contact-agent interaction, such as a refund or courtesy credit, an upgrade or downgrade in services, a cancellation of services, or a request to a dispatch center system to schedule a "truck roll" or field agent to attend to the contact's support request. These updates may be further stored in one or more databases. In another customer support application (e.g. IT help desk queue environment), contact's query/request/task completion outcome may be stored in one or more databases.

When the contact disconnects from the contact center system (e.g., hangs up the phone, exits the web chat), additional information may be stored in one or more databases. For example, the at least one communication switch may be configured to record the disconnection time (or end time) and/or the duration of the interaction in one or more databases.

In any of these cases, the assigned agent and/or its associated computing system may record a timestamp associated with the outcome record and/or changes to other records in one or more databases (e.g. the outcome records database, CRM databases). In some scenarios, the timestamp associated with an agent completing an outcome record may be during a contact interaction. In other scenarios, the timestamp associated with the agent completing the outcome record may be after the conclusion of the contact interaction.

For example, a contact arrived at a communication switch network (e.g., 120A, 120B, 171A, 172A, 171B, or 172B) at 10:00 AM. A pairing module (e.g., 174A, 174B, 174C, or 174D) communicatively coupled to or included in a data processing module (e.g. 191A, 191B, or 140) instructed/configured the communication switch network to pair the contact with an agent, who was available for assignment to the contact, based on at least one contact-agent pairing strategy. The communication switch network connected the contact to the agent at 10:02 AM, and the interaction began. During the interaction, the contact decided to instruct the agent to complete a task (e.g. solving an IT related issue, purchasing a new cellphone, amending the contact's current profile, etc.). The agent recorded information associated with the task and the completion of the task, for example, using its associated computing system, and completed the task at 10:10 AM. The agent subsequently disconnected with the contact at 10:12 AM. After disconnecting with the contact, the agent entered a few additional notes in the associated computing system in regards to the interaction with the contact, the task, the completion of the task, and/or other information.

The pairing of the contact and the agent by the at least one pairing strategy may have been logged in one or more databases (e.g., the historical assignment databases). The date, start time, end time and/or duration of the contact interaction event may have been logged in one or more databases (e.g., the contact center database). The fact that the requested task was completed, as well as other relevant information of the task, the date and time of the completion of the task, and/or identities of the contact who submitted the task and agent who completed the task, may have been logged in one or more databases (e.g. the outcome records database). Information about the contact (e.g. derived from the interaction and/or from the task) may have been logged in one or more databases (e.g. the CRM database). It will be appreciated that a large number of contact interactions may be recorded over the course of an hour or day in a real-world contact center environment with a number of agents, resulting a large number of records with fields and values.

As mentioned earlier, outcome records may be stored separately (e.g. in different databases) and in an unstructured/unrelated manner relative to interaction records of contacts and agents. Additionally or alternatively, information associated with one interaction records may have different fields and values and be stored separately (e.g. in different databases) and in an unstructured/unrelated manner relative to each other. Moreover, in some environments, a database stored on one system may be in a different time zone or otherwise out of time synchronization with another database stored on another system. In these embodiments, particularly, providing quality or accurate training/reference data that joins the communication interaction records and the related outcome records for using in the at least one machine learning model or other mathematic models of the at least one pairing module for recommending or pairing purposes has been found challenging while critical in terms of determining desired pairing strategies and/or contact-agent pairs for operating the at least one communication switch network so as to provide a more efficient or better-performed communication system.

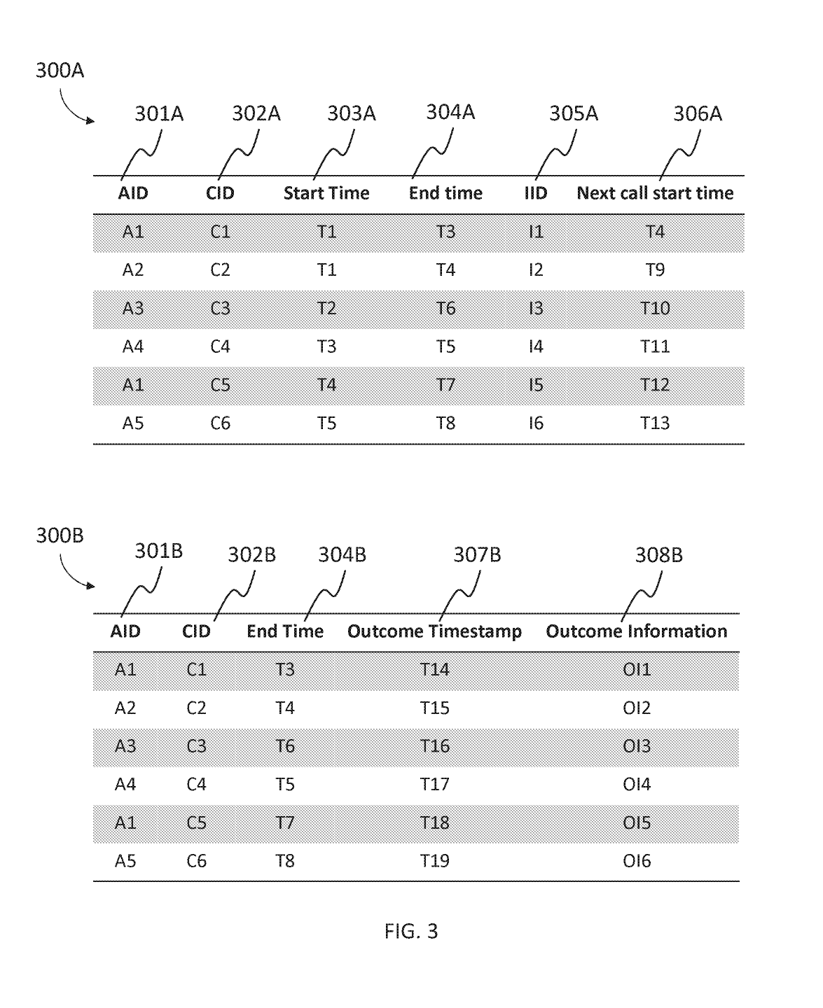

FIG. 3 illustrates exemplary databases 300A and 300B. The first exemplary database 300A includes a first plurality of communication interaction records. Each communication interaction record in the first plurality of communication interaction records comprises first values of a first set of fields including, e.g., agent identification information (AID) 301A, customer identification information (CID) 302A, start time 303A, end time 304A, interaction identification information (IID) 305A, and next call start time 306A in this example, although any fields related to agent information, contact information, and interaction information may be used. The second exemplary database 300B includes a first plurality of communication outcome records. Each communication outcome record in the first plurality of communication outcome records comprises second values of a second set of fields including e.g., agent identification information 301B, customer identification information 302B, end time 304B, outcome timestamp 307B, and outcome information 308B in this example, although any fields related to agent information, contact information, and outcome information may be used. In other examples, two databases for joining records may both include communication interaction records or communication outcome records.

One or more joining strategies can be determined at the at least one data processing module (e.g., 140, 191A, 192A) to obtain one or more sets of joined interaction-outcome records. It will be understood that there may be transformations to allow comparisons/joining of different values of the same field from different databases for forming the one or more joining strategies. For example, a contact signature voice and its associated billing telephone number (BTN) are fields, each of which may provide contact identification information when compared and/or joined. Contact signature voice and its associated BTN may be recorded in a central database. In the examples where a communication interaction record with contact signature voice is recorded in an interaction database while an outcome record with contact BTN is recorded in an outcome database, joining these interaction record and outcome record may require matching based on information recorded in the central database. Additionally or alternatively, one or more constraints, thresholds, and/or relationships between different fields may facilitate forming the one or more joining strategies. Some exemplary joining strategies for joining the communication interaction records in the exemplary database 300A and the communication outcome records in the exemplary database 300B are provided below.

One or more of the following joining techniques may be used to join records between a set of databases. Although two databases are discussed herein, joining techniques may be applied to any number of databases. Additionally, one or more steps of any the joining techniques may be combined with one or more steps of another joining technique, depending on the structure of the databases. For example, if a first database comprises the fields 301A, 302A, 303A, and 308B, and a second database comprises the fields 302B, and 304B, a joining technique may be used which compares (1) 301A and 302B and (2) 308B and 304B.

That is, even though the following joining techniques are discussed sequentially, they may not be performed sequentially or specific joining techniques may not be performed even at all, as discussed further herein. For example, although a third joining strategy may yield a third set of joined interaction-outcome records, that third set of joined interaction-outcome records may be the only set of joined interaction-outcome records created for its respective set of databases.

In a first exemplary joining strategy (JS1), the at least one data processing module may be configured to determine (1) if a value of the field of AID 301A in an interaction record in the database 300A matches with a value of the field of AID 301B in an outcome record in the database 300B, (2) if a value of the field of CID 302A in the interaction record in the database 300A matches with a value of the field of CID 302B in the outcome record in the database 300B, (3) if a value of the field of start time 303A in the interaction record in the database 300A indicates a time earlier than a time indicated by a value of the field of outcome timestamp 307B in the outcome record in the database 300B, and (4) if a value of the field of end time 304A in the interaction record in the database 300A indicates a time later than or equal to a time indicated by the value of the field of outcome timestamp 307B in the outcome record in the database 300B. Depending on the applications, the task could be completed during or shortly after the interaction conclusion (i.e. the end time of the interaction). Having determined that the interaction record in the database 300A is associated with the outcome record in the database 300B, a joined interaction-outcome record is obtained at the at least one data processing module. After executing the first joining strategy on at least one of the plurality interaction records in the database 300A and at least one of the plurality outcome records in the database 300B, a first set of joined interaction-outcome records is obtained, wherein each record of the first set of joined interaction-outcome records comprises one record of the plurality of communication interaction records in the first database 300A and one record of the plurality of communication outcome records in the second database 300B.

In a second exemplary joining strategy (JS2), the at least one data processing module may be configured to determine (1) if a value of the field of AID 301A in an interaction record in the database 300A matches with a value of the field of AID 301B in an outcome record in the database 300B, (2) if a value of the field of CID 302A in the interaction record in the database 300A matches with a value of the field of CID 302B in the outcome record in the database 300B, (3) if a value of the field of start time 303A in the interaction record in the database 300A indicates a time earlier than a time indicated by a value of the field of outcome timestamp 307B in the outcome record in the database 300B, and (4) if the addition of a value of the field of end time 304A in the interaction record in the database 300A and a buffer time value (e.g., a 15-second buffer, a 30-second buffer, a 45-second buffer, a 1-minute buffer, a 2-minute buffer, a 5-minute buffer, a 10-minute buffer, etc.) indicates a time later than or equal to a time indicated by the value of the field of outcome timestamp 307B in the outcome record in the database 300B. Having determined that the interaction record in the database 300A is associated with the outcome record in the database 300B, a joined interaction-outcome record is obtained at the at least one data processing module. After executing the second joining strategy on at least one of the plurality interaction records in the database 300A and at least one of the plurality outcome records in the database 300B, a second set of joined interaction-outcome records is obtained, wherein each record of the second set of joined interaction-outcome records comprises one record of the plurality of communication interaction records in the first database 300A and one record of the plurality of communication outcome records in the second database 300B.

In a third exemplary joining strategy (JS3), the at least one data processing module may be configured to determine (1) if a value of the field of AID 301A in an interaction record in the database 300A matches with a value of the field of AID 301B in an outcome record in the database 300B, (2) if a value of the field of CID 302A in the interaction record in the database 300A matches with a value of the field of CID 302B in the outcome record in the database 300B, (3) if a value of the field of start time 303A in the interaction record in the database 300A indicates a time earlier than a time indicated by a value of the field of outcome timestamp 307B in the outcome record in the database 300B, and (4) if a value of the field of next call start time 306A in the interaction record in the database 300A indicates a time later than or equal to a time indicated by the value of the field of outcome timestamp 307B in the outcome record in the database 300B. Having determined that the interaction record in the database 300A is associated with the outcome record in the database 300B, a joined interaction-outcome record is obtained at the at least one data processing module. After executing the third joining strategy on at least one of the plurality interaction records in the database 300A and at least one of the plurality outcome records in the database 300B, a third set of joined interaction-outcome records is obtained, wherein each record of the third set of joined interaction-outcome records comprises one record of the plurality of communication interaction records in the first database 300A and one record of the plurality of communication outcome records in the second database 300B.

In a fourth exemplary joining strategy (JS4), the at least one data processing module may be configured to determine (1) if a value of the field of AID 301A in an interaction record in the database 300A matches with a value of the field of AID 301B in an outcome record in the database 300B, (2) if a value of the field of CID 302A in the interaction record in the database 300A matches with a value of the field of CID 302B in the outcome record in the database 300B, (3) if a value of the field of start time 303A in the interaction record in the database 300A indicates a time earlier than a time indicated by a value of the field of outcome timestamp 307B in the outcome record in the database 300B, and (4) if the addition of a value of the field of next call start time 306A in the interaction record in the database 300A and a buffer time (e.g., a 15-second buffer, a 30-second buffer, a 45-second buffer, a 1-minute buffer, a 2-minute buffer, a 5-minute buffer, a 10-minute buffer, etc.) indicates a time later than or equal to a time indicated by the value of the field of outcome timestamp 307B in the outcome record in the database 300B. Having determined that the interaction record in the database 300A is associated with the outcome record in the database 300B, a joined interaction-outcome record is obtained at the at least one data processing module. After executing the fourth joining strategy on at least one of the plurality interaction records in the database 300A and at least one of the plurality outcome records in the database 300B, a fourth set of joined interaction-outcome records is obtained, wherein each record of the fourth set of joined interaction-outcome records comprises one record of the plurality of communication interaction records in the first database 300A and one record of the plurality of communication outcome records in the second database 300B.

In a fifth exemplary joining strategy (JS5), the at least one data processing module may be configured to determine (1) if a value of the field of AID 301A in an interaction record in the database 300A matches with a value of the field of AID 301B in an outcome record in the database 300B, (2) if a value of the field of CID 302A in the interaction record in the database 300A matches with a value of the field of CID 302B in the outcome record in the database 300B, and (3) if a date associated with the field of start time 303A in the interaction record in the database 300A is equal to a date associated with the field of outcome timestamp 307B in the outcome record in the database 300B. Having determined that the interaction record in the database 300A is associated with the outcome record in the database 300B, a joined interaction-outcome record is obtained at the at least one data processing module. After executing the fifth joining strategy on at least one of the plurality interaction records in the database 300A and at least one of the plurality outcome records in the database 300B, a fifth set of joined interaction-outcome records is obtained, wherein each record of the fifth set of joined interaction-outcome records comprises one record of the plurality of communication interaction records in the first database 300A and one record of the plurality of communication outcome records in the second database 300B.

In a sixth exemplary joining strategy (JS6), the at least one data processing module may be configured to determine (1) if a value of the field of AID 301A in an interaction record in the database 300A matches with a value of the field of AID 301B in an outcome record in the database 300B, (2) if a value of the field of start time 303A in the interaction record in the database 300A indicates a time earlier than a time indicated by a value of the field of outcome timestamp 307B in the outcome record in the database 300B, and (3) if a value of the field of end time 304A in the interaction record in the database 300A indicates a time later than or equal to a time indicated by the value of the field of outcome timestamp 307B in the outcome record in the database 300B. Having determined that the interaction record in the database 300A is associated with the outcome record in the database 300B, a joined interaction-outcome record is obtained at the at least one data processing module. After executing the sixth joining strategy on at least one of the plurality interaction records in the database 300A and at least one of the plurality outcome records in the database 300B, a sixth set of joined interaction-outcome records is obtained, wherein each record of the sixth set of joined interaction-outcome records comprises one record of the plurality of communication interaction records in the first database 300A and one record of the plurality of communication outcome records in the second database 300B.

In a seventh exemplary joining strategy (JS7), the at least one data processing module may be configured to determine (1) if a value of the field of AID 301A in an interaction record in the database 300A matches with a value of the field of AID 301B in an outcome record in the database 300B, (2) if a value of the field of start time 303A in the interaction record in the database 300A indicates a time earlier than a time indicated by a value of the field of outcome timestamp 307B in the outcome record in the database 300B, and (3) if a value of the field of next call start time 306A in the interaction record in the database 300A indicates a time later than or equal to a time indicated by the value of the field of outcome timestamp 307B in the outcome record in the database 300B. Having determined that the interaction record in the database 300A is associated with the outcome record in the database 300B, a joined interaction-outcome record is obtained at the at least one data processing module. After executing the third joining strategy on at least one of the plurality interaction records in the database 300A and at least one of the plurality outcome records in the database 300B, a seventh set of joined interaction-outcome records is obtained, wherein each record of the seventh set of joined interaction-outcome records comprises one record of the plurality of communication interaction records in the first database 300A and one record of the plurality of communication outcome records in the second database 300B.

In an eighth exemplary joining strategy (JS8), the at least one data processing module may be configured to determine (1) if a value of the field of CID 302A in an interaction record in the database 300A matches with a value of the field of CID 302B in an outcome record in the database 300B, (2) if a value of the field of start time 303A in the interaction record in the database 300A indicates a time earlier than a time indicated by a value of the field of outcome timestamp 307B in the outcome record in the database 300B, and (3) if a value of the field of end time 304A in the interaction record in the database 300A indicates a time later than or equal to a time indicated by the value of the field of outcome timestamp 307B in the outcome record in the database 300B. Having determined that the interaction record in the database 300A is associated with the outcome record in the database 300B, a joined interaction-outcome record is obtained at the at least one data processing module. After executing the eighth joining strategy on at least one of the plurality interaction records in the database 300A and at least one of the plurality outcome records in the database 300B, an eighth set of joined interaction-outcome records is obtained, wherein each record of the eighth set of joined interaction-outcome records comprises one record of the plurality of communication interaction records in the first database 300A and one record of the plurality of communication outcome records in the second database 300B.

In this regard, the at least one data processing module is configured to determine a first plurality of joining strategies (e.g., one or more of JS1, JS2, …, JS8 or as otherwise discussed herein) based on at least some of the first set of fields in the first database and the second set of field of the second database and obtain a plurality of sets of joined interaction-outcome records, wherein each set of joined interaction-outcome records is obtained based on a corresponding joining strategy, and each record of each set of joined interaction-outcome records comprises one record of the plurality of communication interaction records in the first database (e.g., 300A) and one record of the plurality of communication outcome records in the second database (e.g., 300B).

In some examples, when multiple joining strategies are used for the same set of databases, subsequent joining strategies may be more permissive or have less constraints than prior joining strategies. For example, the sixth exemplary joining strategy (JS6) is strictly more permissive than the first exemplary joining strategy (JS1).

The at least one data processing module may be further configured to determine respective measurements of a plurality of joining strategies (e.g., the first plurality of joining strategies) based on an overlap between one set of joined interaction-outcome records and another set of joined interaction-outcome records. The at least one data processing module is then configured to determine a reference set of joined interaction-outcome records based on the respective measurements of the plurality of joining strategies. In some embodiments, the respective measurements of the plurality of joining strategies indicate respective joining confidence levels of the plurality of joining strategies.

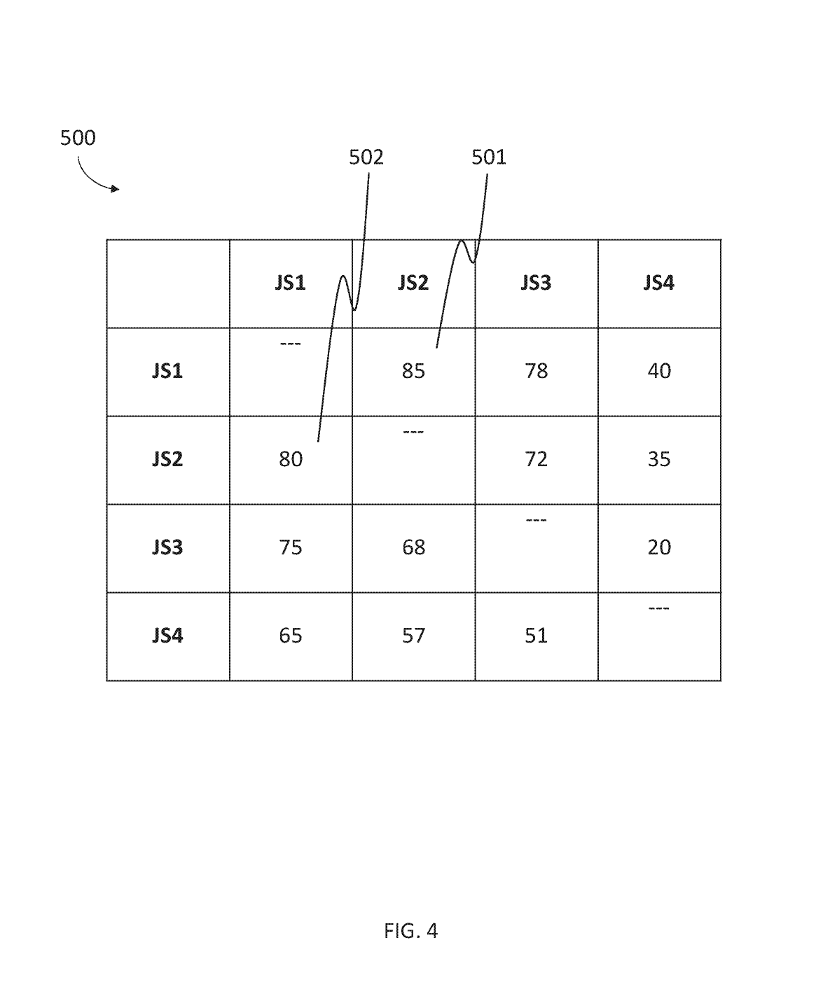

For example, FIG. 4 illustrates an agreement matrix 500 demonstrating an agreement between two of multiple joining strategies (e.g., a first joining strategy JS1, a second joining strategy JS2, a third joining strategy JS3, and a fourth joining strategy JS4). Each of these four joining strategies may be one of the joining strategies discussed above, or may be any joining strategy contemplated herein. In one example, cell 501 demonstrates that 85% of the first set of joined records created based on JS1 are also found in (i.e., overlapped with) the second set of joined records created based on JS2. In another example, cell 502 demonstrates that 80% of the second set of joined records created based on JS2 are also found in (i.e., overlapped with) the first set of joined records created based on JS1.

In this regard, the at least one data processing module is further configured to determine a ranking for executing the first plurality of joining strategies (i.e., JS1, JS2, …) based on the respective measurements of the plurality of joining strategies, and execute the first plurality of joining strategies to join the records of a set of databases (e.g., 300A and 300B) in a sequence according to the ranking. In other examples, a permissiveness of each joining strategy is taken into account such that more permissive joining strategies are always executed after the less permissive joining strategies. Therefore, the plurality of joining strategies may be executed based on both permissiveness and a ranking.

In some embodiments, to determine the reference set of joined records, the at least one data processing module is further configured to execute one joining strategy of the first plurality of joining strategies with a highest ranking to the first and second databases to obtain a set of joined records (e.g., joined interaction-outcome records), and execute another joining strategy of the first plurality of joining strategies with a lower ranking to unjoined records of the first and second databases.

For example, in the example as illustrated in FIG. 4, JS1 may be determined as a joining strategy with a highest ranking so that the at least one data processing module is configured to execute JS1 to the databases 300A and 300B to obtain a set of joined records. The at least one data processing module is then configured to subsequentially execute JS2 (with a lower ranking than JS1) to remaining records in the databases 300A and 300B that have not been joined by JS1 to obtain another set of joined records. The at least one data processing module is further configured to subsequentially execute JS3 (with a lower ranking than JS2) to remaining records in the databases 300A and 300B that have not been joined by JS1 and JS2 to obtain another set of joined records, and so on.

In some examples, one or more of the first plurality of joining strategies may be excluded from execution based on its respective measurements. For example, there may be a threshold measurement that the respective measurement should score better than in order to be used.

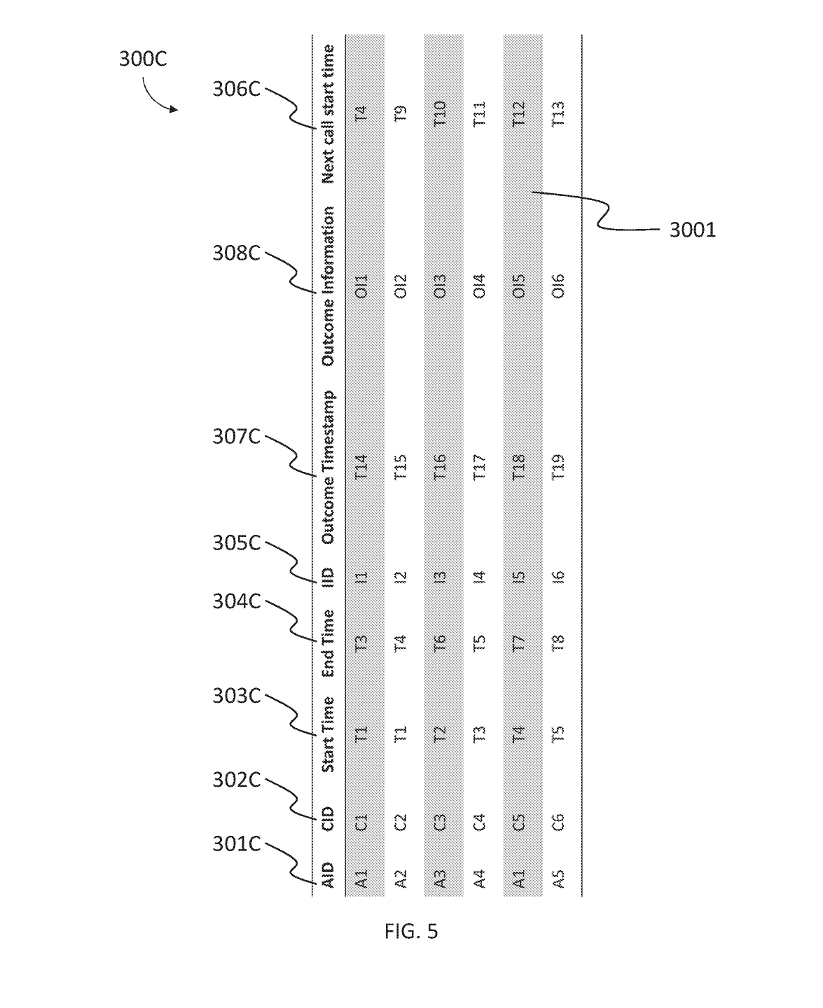

After all of or a selected portion of the first plurality of joining strategies have been executed (e.g., a selected portion based on determining that one or more of the first plurality of joining strategies should be excluded) and/or after a sufficient number and/or percentage of records in the databases have been joined and/or other termination requests are received, a reference set of joined records (e.g. joined interaction-outcome records) based on the respective measurements of a plurality of joining strategies is obtained at the at least one data processing module. FIG. 5 illustrates a plurality of joined interaction-outcome records 300C based on the exemplary databases 300A and 300B of FIG. 3. The reference set of joined records comprises at least one of the joined records created based on at least one of the executed joining strategies. In an example where two or more joining strategies are executed for generating the reference set of joined records, the reference set of joined records may comprise at least one of: records in a first set of joined interaction-outcome records obtained based on a first joining strategy of the plurality of joining strategies; records in a second set of joined interaction-outcome records obtained based on a second joining strategy of the plurality of joining strategies; and/or a combination of records in the first set of joined interaction-outcome records and records in the second set of joined interaction-outcome records.

In some embodiments, the at least one data processing module is further configured to determine at least one weight for at least one record of the reference set of joined interaction-outcome records, e.g., for using at the one or more pairing module with the reference set of joined interaction-outcome records to generate at least one contact-agent pairing strategy. For example, the at least one weight may indicate a confidence that the at least one record is an actual match. For example, the at least one weight may be generated based on an agreement matrix and/or otherwise respective measurements of the one or more joining strategies used to generate the at least one record. Therefore, the at least one weight may indicate a reliability of the record when the at least one record is used to train or otherwise generate the at least one contact-agent pairing strategy.

In one example, the at least one weight for the at least one record of the reference set of joined interaction-outcome records is determined based on the respective measurements of relevant joining strategies. For example, joined record 3001 may have been matched only by JS3 and JS4. As illustrated in FIG. 4, it is determined that JS3 has an average accuracy of around 54% (i.e., (75+68+20)/3) while JS4 has an average accuracy of around 58% (i.e., (65+57+51)/3). In this regard, a weight for the joined record 3001 is determined based on the 54% measurement of JS3 and the 58% measurement of JS4. In another example, the measurements of JS3 and JS4 may be based on their measurements with respect to a reference joining strategy (or called 'verified'/'accepted-as-true' joining strategy), such as JS1. As illustrated in FIG. 4, the measurement of JS3 with respect to JS1 is 75% while the measurement of JS4 with respect to JS1 is 65%. In this regard, a weight for the joined record 3001 is determined based on the 75% measurement of JS3 and the 65% measurement of JS4.

The at least one pairing module is then configured to determine at least one contact-agent pairing and/or pairing strategy for at least one contact center system based on the reference set of joined interaction-outcome records with or without the respective weight(s) of at least one record in the reference set of joined interaction-outcome records. The at least one communication switch network is configured to connect a contact with an agent based on the at least one contact-agent pairing/pairing strategy.

In some embodiments, the at least one data processing module is further configured to determine benchmarking between one pairing strategy and another pairing strategy based on the reference set of joined interaction-outcome records. For example, a first pairing strategy may be generated based on a first plurality of joining strategies and an associated first reference set of joined interaction-outcome records and a second pairing strategy may be generated based on a second plurality of joining strategies and an associated second reference set of joined interaction-outcome records. The contact center system may cycle between the first pairing strategy and the second pairing strategy and determine performance measurements for each of the first pairing strategy and the second pairing strategy.

In the above examples, the first database (e.g. 300A) includes a first plurality of communication interaction records, wherein each communication interaction record in the first plurality of communication interaction records comprises first values for a first set of fields, while the second database (e.g. 300B) includes a first plurality of communication outcome records, wherein each communication outcome record in the first plurality of communication outcome records comprises second values for a second set of fields.

In other examples, information associated with one interaction may have different fields and values which may be stored separately in different databases. For example, a third database is configured to provide a second plurality of communication interaction records, wherein each communication interaction record in the second plurality of communication interaction records comprises third values for a third set of fields, while a fourth database is configure to provide a third plurality of communication interaction records, wherein each communication interaction record in the third plurality of communication interaction records comprises fourth values for a fourth set of fields. The third set of fields is different from the fourth set of fields. Similarly, the information associated with one outcome record may have different fields and values which may be stored separately in different databases. In this regard, the at least one data processing module is configured to join the interaction records from different databases and/or to join the outcome records from the different databases before obtaining the joined interaction-outcome records.

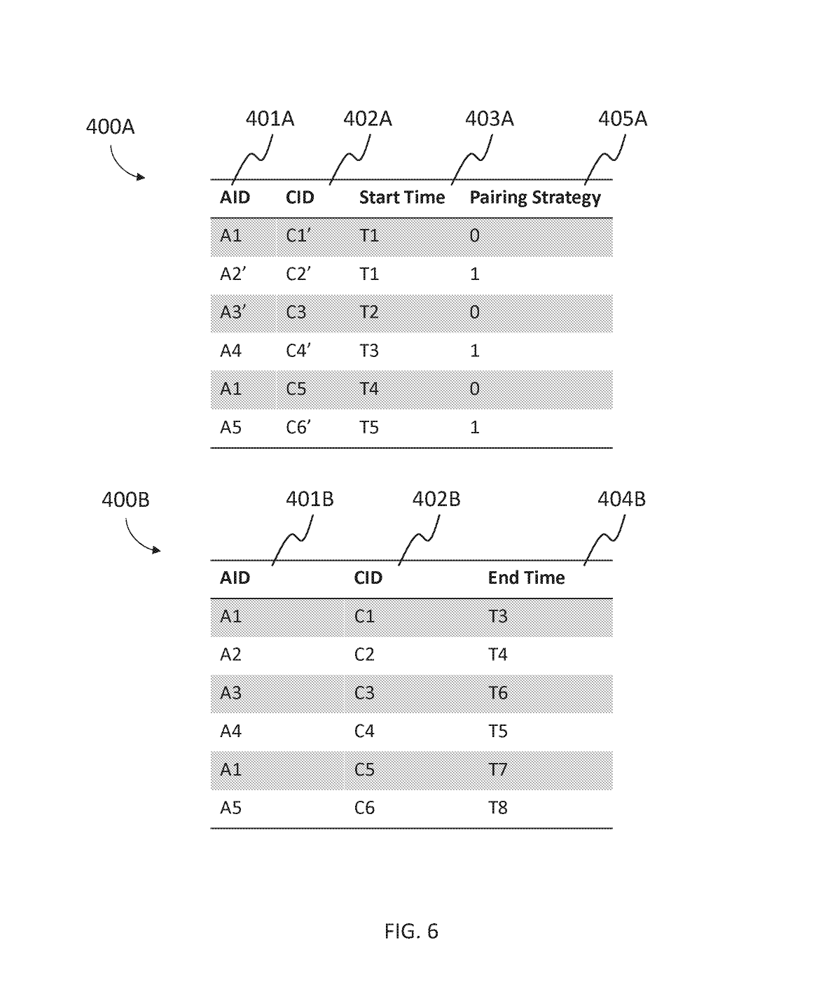

FIG. 6 illustrates exemplary third and fourth databases 400A and 400B each with a plurality of communication interaction records. Each communication interaction record in a second plurality of communication interaction records in the database 400A comprises third features/values of a third set of fields including agent identification information (AID) 401A, customer identification information (CID) 402A, start time 403A, pairing strategy 405A. The fourth exemplary database 400B includes a third plurality of communication interaction records. Each communication interaction record in the third plurality of communication interaction records comprises fourth features/values of a fourth set of fields including agent identification information 401B, customer identification information 402B, and end time 404B. In some embodiments, for the same field, the databases 400A and 400B may record different features/values. For example, a contact signature voice, its associated ID and its associated billing telephone number (BTN) or contact number are different values of the field of contact identification information CID. Contact signature voice (e.g., C1', C2', C4', C6') may be recorded in the database 400A while the contact number (e.g., C1-C6) may be recorded in the database 400B.

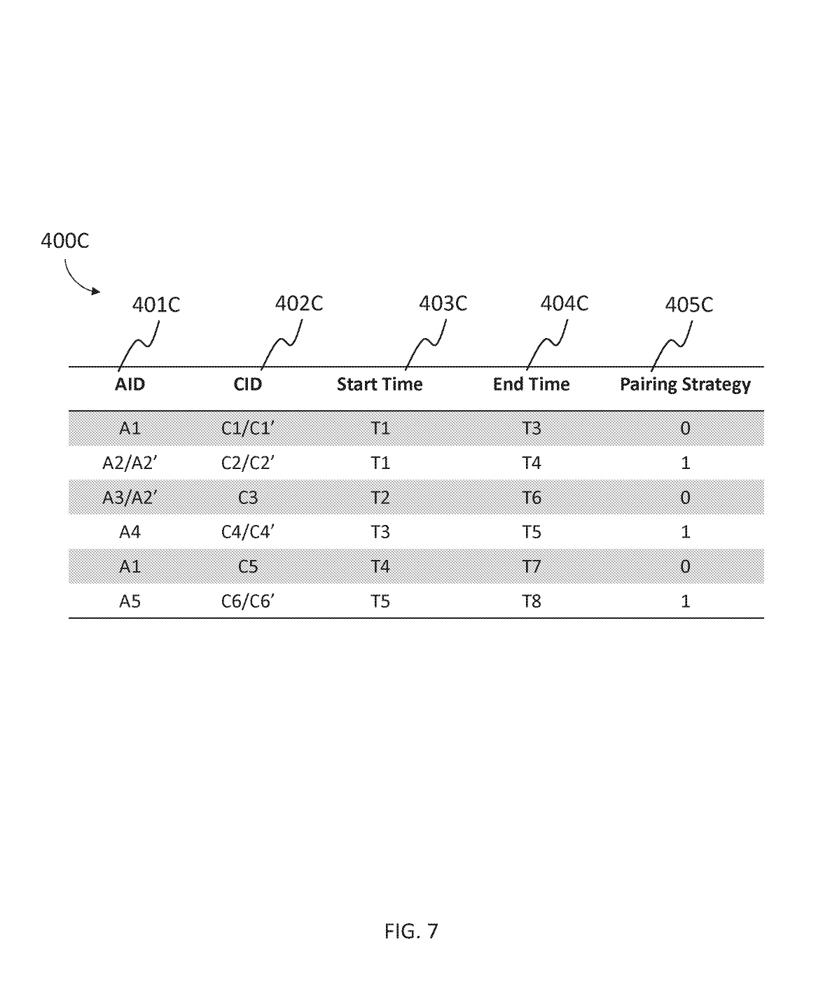

As discussed above, there may be transformations to allow comparisons/joining of different features/values of the same field for different databases for forming a second plurality of joining strategies so as to combine at least some of the communication interaction records from the interaction record databases 400A and 400B. Additionally or alternatively, one or more constraints, thresholds, and/or relationships between different fields may facilitate forming the second plurality of joining strategies for joining at least some of the communication interaction records from the interaction record databases 400A and 400B. FIG. 7 illustrates a plurality of exemplary joined interaction records based on the exemplary databases of FIG. 6 (e.g., the set of joined interaction records shown in FIG. 7 is created based on one or more joining strategies as discussed herein).

Accordingly, a plurality of joined communication interaction/outcome records by joining the second plurality of communication interaction/outcome records and the third plurality of communication interaction/outcome records are obtained and can be used to join with a plurality of outcome/interaction records for generating the reference set of joined interaction-outcome records as discussed above. Depending on the fields in the databases, the second plurality of joining strategies for joining the interaction/outcome records may include one or more joining strategies for joining the interaction records and outcome records.

It should be appreciated by the skilled person in the art that at least one of the described arrangements for joining interaction and outcome records may have one or more of the following advantages: i) improved efficiency of the use of multiple databases; ii) improved accuracy for combining records in multiple databases; iii) improved quality of training data to train one or more models for generating pairing strategies and/or for recommending contact-agent pairs; iv) improved recommending efficiency and accuracy in real-time operations of a contact center system; v) improved operation efficiency of the contact center including improved efficiency of communication routing and resource allocation/management; and vi) improved performance of the contact center including increasing the number of incoming tasks/queries that can be complete, reducing excessive delays and latency for handling the incoming tasks/queries, improved revenue, improved user (contacts and/or agents) experience/satisfaction, etc.

In this specification, adjectives such as left and right, top and bottom, first, second, third, fourth, fifth, sixth, seventh and eighth, and the like may be used to distinguish one element or action from another element or action without necessarily requiring or implying any actual such relationship or order. Where context permits, reference to a component, an integer or step (or the alike) is not to be construed as being limited to only one of that component, integer, or step, but rather could be one or more of that component, integer or step.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

The above description relating to embodiments of the present disclosure is provided for purposes of description to one of ordinary skill in the related art. It is not intended to be exhaustive or to limit the disclosure to a single disclosed embodiment. As mentioned above, numerous alternatives and variations to the present disclosure will be apparent to those skilled in the art from the above teaching. Accordingly, while some alternative embodiments have been discussed specifically, other embodiments will be apparent or relatively easily developed by those of ordinary skill in the art. The present disclosure is intended to embrace all modifications, alternatives, and variations that have been discussed herein, and other embodiments that fall within the spirit and scope of the above description.

1. A communication system comprising:
a first database configured to provide a first plurality of communication interaction records, wherein each communication interaction record in the first plurality of communication interaction records comprises first values for a first set of fields;
a second database configured to provide a first plurality of communication outcome records, wherein each communication outcome record in the first plurality of communication outcome records comprises second values for a second set of fields;
at least one data processing module configured to:
determine a first plurality of joining strategies based on at least some of the first set of fields and the second set of fields;
obtain a plurality of sets of joined interaction-outcome records, wherein each set of joined interaction-outcome records is obtained based on a corresponding joining strategy, and each record of each set of joined interaction-outcome records comprises one record of the first plurality of communication interaction records and one record of the first plurality of communication outcome records;
determine respective measurements of the first plurality of joining strategies based on an overlap between one set of joined interaction-outcome records and another set of joined interaction-outcome records; and
determine a reference set of joined interaction-outcome records based on the respective measurements of the plurality of joining strategies;
at least one pairing module configured to determine at least one contact-agent pairing strategy for at least one contact center system based on the reference set of joined interaction-outcome records; and
at least one communication switch network configured to connect a contact with an agent based on the at least one contact-agent pairing strategy.

2. The communication system of claim 1, wherein
the first set of fields comprises fields associated with a contact-agent interaction at the at least one contact center system.

3. The communication system of claim 1, wherein
the second set of fields comprises fields associated with an outcome of a contact-agent interaction at the at least one contact center system.

4. The communication system of claim 1, wherein
the reference set of joined interaction-outcome records comprises:
records in a first set of joined interaction-outcome records obtained based on a first joining strategy of the plurality of joining strategies,
records in a second set of joined interaction-outcome records obtained based on a second joining strategy of the plurality of joining strategies, and/or
a combination of records in the first set of joined interaction-outcome records and records in the second set of joined interaction-outcome records.

5. The communication system of claim 1, wherein
the at least one data processing module is further configured to determine benchmarking between a first contact-agent pairing strategy and a second contact-agent pairing strategy based on the reference set of joined interaction-outcome records.

6. The communication system of claim 1, wherein
the at least one communication switch network comprises at least one demilitarized zone equipment.

7. The communication system of claim 1, wherein
the at least one communication switch network comprises at least one web demilitarized zone equipment and at least one telephony demilitarized zone equipment.

8. The communication system of claim 1, wherein
the at least one data processing module is further configured to:
determine a ranking for executing the first plurality of joining strategies based on the respective measurements of the plurality of joining strategies; and
execute the first plurality of joining strategies to the first and second databases in a sequence according to the ranking.

9. The communication system of claim 8, wherein
the at least one data processing module is further configured to:
execute one joining strategy of the first plurality of joining strategies with a highest ranking to the first and second databases to obtain a set of joined interaction-outcome records; and
execute another joining strategy of the first plurality of joining strategies with a lower ranking to unjoined records of the first and second databases.

10. The communication system of claim 1, wherein
the respective measurements of the first plurality of joining strategies indicate respective joining confidence levels of the plurality of joining strategies.

11. The communication system of claim 1, wherein
the at least one data processing module is further configured to determine at least one weight for at least one record in the reference set of joined interaction-outcome records.

12. The communication system of claim 11, wherein
the at least one weight is determined based on the respective measurements of one or more of the first plurality of joining strategies.

13. The communication system of claim 11, wherein
the at least one pairing module is configured to provide the at least one contact-agent pairing strategy for the at least one contact center system based on the reference set of joined interaction-outcome records and the at least one weight of the at least one record of the reference set of joined interaction-outcome records.

14. The communication system of claim 1, wherein
the communication system further comprises:
a third database configured to provide a second plurality of communication interaction records, wherein each communication interaction record in the second plurality of communication interaction records comprises third values for a third set of fields; and
a fourth database configured to provide a third plurality of communication interaction records, wherein each communication interaction record in the third plurality of communication interaction records comprises fourth values for a fourth set of fields, wherein
the third set of fields is different from the fourth set of fields, and
the at least one data processing module is configured to obtain the first plurality of communication interaction records by joining the second plurality of communication interaction records and the third plurality of communication interaction records based on at least one of the first plurality of joining strategies.

15. The communication system of claim 1, wherein
the communication system further comprises:
a third database configured to provide a second plurality of communication interaction records, wherein each communication interaction record in the second plurality of communication interaction records comprises third values for a third set of fields; and
a fourth database configured to provide a third plurality of communication interaction records, wherein each communication interaction record in the third plurality of communication interaction records comprises fourth values for a fourth set of fields, wherein
the at least one data processing module is further configured to:
determine a second plurality of joining strategies; and
obtain the first plurality of communication interaction records by joining the second plurality of communication interaction records and the third plurality of communication interaction records based on at least one of the second plurality of joining strategies.

16. A method comprising:
obtaining a first plurality of communication interaction records from a first database, wherein each communication interaction record in the first plurality of communication interaction records comprises first values for a first set of fields;
obtaining a first plurality of communication outcome records from a second database, wherein each communication outcome record in the first plurality of communication outcome records comprises second values for a second set of fields;
determining a first plurality of joining strategies based on at least some of the first set of fields and the second set of fields;
obtaining a plurality of sets of joined interaction-outcome records, wherein each set of joined interaction-outcome records is obtained based on a corresponding joining strategy, and each record of each set of joined interaction-outcome records comprises one record of the first plurality of communication interaction records and one record of the first plurality of communication outcome records;
determining respective measurements of the first plurality of joining strategies based on an overlap between one set of joined interaction-outcome records and another set of joined interaction-outcome records; and
determining a reference set of joined interaction-outcome records based on the respective measurements of the plurality of joining strategies.

17. The method of claim 16, wherein
the method further comprises:
determining at least one contact-agent pairing strategy for at least one contact center system based on the reference set of joined interaction-outcome records; and
connecting a contact with an agent based on the at least one contact-agent pairing strategy.

18. The method of claim 16, wherein
the first set of fields comprises fields associated with a contact-agent interaction at least one contact center system.

19. The method of claim 16, wherein
the second set of fields comprises fields associated with an outcome of a contact-agent interaction at at least one contact center system.

20. The method of claim 16, wherein
the reference set of joined interaction-outcome records comprises:
records in a first set of joined interaction-outcome records obtained based on a first joining strategy of the plurality of joining strategies,
records in a second set of joined interaction-outcome records obtained based on a second joining strategy of the plurality of joining strategies, and/or
a combination of records in the first set of joined interaction-outcome records and records in the second set of joined interaction-outcome records.
